(19) United States
(12) Patent Application Publication
(10) Pub. No.: US 2001/0051330 A1
(43) Pub. Date: Dec. 13, 2001

(54) Apparatus and method for providing remote teaching

(75) Inventor: Michio Futakuchi, Tokyo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/732,889

(22) Filed: Dec. 11, 2000

(30) Foreign Application Priority Data
Jun. 8, 2000 (JP) 2000-171820

(51) Int. Cl. G09B 3/00; G09B 5/00

(52) U.S. Cl. 434/322

(57) ABSTRACT

An apparatus for providing remote teaching to a student at a terminal through a network. The apparatus comprises a question database including questions, an answer database including an answer key, and a comment database including one or more common wrong answers students are apt to make, prepared respectively for each question. The comment database also includes mistake indicating comments to the respective common wrong answers. The mistake indicating comments are designed to let a student know that his/her answer is wrong and why. The apparatus further comprises a control unit configured to, after an answer is received from the student, determine based on the answer key whether the answer is right. The control unit is further configured to, when the answer is not right, select from the comment database a mistake indicating comment corresponding to both the question given to the student and his/her answer for providing the comment to the student.

### FIELD OF THE INVENTION

The present invention relates to an apparatus and method for providing remote teaching, and more particularly, to an apparatus and method for remote teaching which utilize a two-way communication to communicate over a network such as the Internet between a provider of remote teaching and its student.

### BACKGROUND OF THE INVENTION

Some remote teaching systems on the Internet have recently been proposed. For instance, FIG. 6 is a block diagram illustrating a conventional remote teaching system on the Internet, which is disclosed in Japanese published patent application No. HEI 10-134028.

As shown in FIG. 6, the system comprises a personal computer (PC) 10 for a student who takes a remote teaching course, and a server 30 for a provider who provides the remote teaching course to the student. The server 30 includes a network connection unit 31, a control unit 32, a remote teaching execution unit 33, a database management unit 34 and a database 35.

A student operates the PC 10 to establish a connection between the PC 10 and the server 30 through the Internet, and takes from the server 30 a list of topics to be learned by the student, such as fractions, integer exponents and linear equations. The student then operates the PC 10 to select a topic he/she wants to learn, from the list.

The control unit 32 controls the remote teaching execution unit 33 and database management unit 34 so that topic data corresponding to the topic selected by the student is provided through the Internet to the student at the PC 10. The topic data, stored in the database 35, is information relating to the topic selected by the student, which helps the student learn, for example, concepts and techniques that are essential in solving problems that commonly appear on the topic.

Specifically, the database management unit 34 retrieves the topic data corresponding to the topic selected by the student from among various topic data stored in the database 35, and sends the topic data to the remote teaching execution unit 33. The remote teaching execution unit 33 creates a learning page(s) including the topic data received and provides the student with the learning page through the Internet. The student learns through the learning page concepts and techniques for solving problems with respect to the topic he/she selected.

After the student finishes his/her study on the learning page, the remote teaching execution unit 33 sends the database management unit 34 information indicating which topic the student learned. The database management unit 34 retrieves from the database 35 evaluation data corresponding to the information, and sends it back to the remote teaching execution unit 33. The evaluation data selected includes exam data that deals exclusively with what the student has learned on the topic he/she selected, and is to be used for evaluating the performance of the student on the topic.

The remote teaching execution unit 33 creates an evaluation page(s) including the evaluation data sent from the database management unit 34, and provides the student with the evaluation page created. The student then takes the exam provided on the evaluation page. After the exam is finished, the remote teaching execution unit 33 takes as input the resultant exam data (for example, including the student's answers to questions provided on the evaluation page). The remote teaching execution unit 33 then makes a grading of the exam based on the exam data and evaluates the student's performance on the exam based on a result of the grading. The remote teaching execution unit 33 also analyzes a result of the evaluation, and then newly sets a curriculum for the student on the basis of the analysis. The remote teaching execution unit 33 then provides the student with a result page(s) showing the result of the evaluation of his/her performance on the exam and the curriculum newly set. The database management unit 34 also receives as input, remote teaching result information including data on the evaluation of the student's performance and the new curriculum from the remote teaching execution unit 33, and stores it in the database 35.

As described above, in the conventional remote teaching system on the Internet, a curriculum is set for each student on the basis of a result of an exam provided to him/her. However, just setting the curriculum based only on the result of the exam does not make it possible for each student to obtain a sufficient educational effect. In other words, it is important from the standpoint of education to let a student know solutions with explanations to questions with which the student had trouble so that the student does not repeatedly make the same mistakes as he/she did before. In more detail, an important thing is to let the student understand what kind of points he/she could not understand or what kind of mistakes he/she made, with respect to questions that he/she could not answer correctly. Although such an educational method can ordinarily be seen in a one-.on-one situation in which a tutor teaches his/her student, such method has not yet been realized in the conventional system on the Internet.

### SUMMARY OF THE INVENTION

According to the present invention, various objects and advantages which become apparent in this specification are attained by an apparatus for providing remote teaching which utilizes a two-way communication to communicate over a network such as the Internet between a provider of remote teaching and its student. That is, the apparatus for providing remote teaching to a student at a terminal connected to the apparatus through a network, comprises a question database including questions to be given to students, an answer database including an answer key for the questions in the question database, and a comment database including one or more common wrong answers students are apt to make, prepared respectively for each question in the question database, and mistake indicating comments corresponding to the respective common wrong answers. The mistake indicating comments are each designed to let a student know that his/her answer is wrong and the reason his/her answer is wrong. The apparatus also comprises a control unit configured to, after an answer to a question given to the student is received from the terminal through the network, determine based on the answer key whether the answer is right. The control unit is also configured to, when it is determined that the answer is not right, select from the comment database a mistake indicating comment corresponding to both the question given to the student and his/her answer for providing the comment to him/her through the network.

In accordance with a described embodiment, the common wrong answers are answers obtained from a result of an examination for students.

Furthermore, the comment database further includes a wrong answer comment designed to let a student know that his/her answer is wrong. The control unit is further configured to select the wrong answer comment for providing it to the student when the control unit has found no mistake indicating comment corresponding to both the question given to the student and his/her answer.

In accordance with one aspect of the invention, the comment database further includes one or more tips prepared respectively for each question in the question database. The tips are each designed to give a student a tip on the answer to a question given to him/her. In addition, the wrong answer comment is further designed to let a student know that he/she may request a tip on the answer to a question given to him/her. The control unit is further configured to, when the student requests a tip to the question, select from the comment database a tip corresponding to the question for providing the tip to the student through the network.

In accordance with a described embodiment, more than one tip addressed to the same question is each designed to contain a tip different from the others. They are also assigned the order in which the tips are provided to a student so that tips are given to the student in a step-by-step manner. The control unit is configured to, when more than one tip is addressed to the question given to the student, select one of the tips based on the number of times the student has requested a tip to the question given to him/her, and the order assigned to each tip.

Furthermore, the control unit is configured to, when more than one tip is consecutively given to the student in response to his/her consecutive requests of a tip to the same question, control the sending of the selected tip in such a way that a newly selected tip following a previously selected tip is sent after the expiration of a predetermined interval.

In accordance with another aspect of the invention, the comment database further includes one or more tips prepared respectively for each question in the question database. The tips are each designed to give a student a tip on the answer to a question given to him/her. The control unit is further configured to determine whether the answer to the question is blank, and if so, select from the comment database a tip corresponding to the question for providing the tip to the student through the network.

In accordance with a described embodiment, more than one tip addressed to the same question is each designed to contain a tip different from the others. They are also assigned the order in which the tips are provided to a student so that tips are given to the student in a step-by-step manner. The control unit is configured to, when more than one tip is addressed to the question given to the student, select one of the tips based on the number of times the answer is left blank and the order assigned to each tip.

Furthermore, the control unit is configured to, when more than one tip is consecutively given to the student in response to his/her consecutive answers left blank, control the sending of the selected tip in such a way that a newly selected tip following a previously selected tip is sent after the expiration of a predetermined interval.

In accordance with still another aspect of the invention, the apparatus further comprises personal databases storing respective students' personal information. The personal information includes a learning history of a student obtained through this remote teaching. The control unit is further configured to refer to the individual database for a student to whom a question is to be given, to select a question appropriate for him/her from the question database.

In accordance with another aspect of the invention, a method and a computer-readable medium bearing instructions that cause one or more processors to perform the method are introduced for providing remote teaching to a student, in which a server for a provider of the remote teaching and a terminal for a student who takes the remote teaching are connected through a network so that the provider provides the student with the remote teaching over the network. The method comprises (a) sending to the terminal a question selected from a question database which includes questions to be given to students, (b) receiving from the terminal an answer to the question, and (c) determining whether the answer is right. When it is determined that the answer is not right, the method provides (d) referencing a comment database that includes one or more common wrong answers students are apt to make, prepared respectively for each question in the question database, and mistake indicating comments corresponding to the respective common wrong answers. The mistake indicating comments are each designed to let a student know that his/her answer is wrong and why. The method then (d) selects a mistake indicating comment corresponding to both the question given to the student and his/her answer, followed by (e) sending the selected comment to the terminal.

In one aspect of the invention, step (a) includes referencing a personal database storing personal information for the student to whom a question is to be given, to select a question appropriate for the student from the question database.

Furthermore, the method further comprises the step of recording a learning history of each student through the remote teaching to build his/her personal information.

In another aspect of the invention, step (d) includes selecting a wrong answer comment included in the comment database when any mistake indicating comment corresponding to both the question given to the student and his/her answer has not been found. The wrong answer comments are designed to let a student know that his/her answer is wrong.

In accordance with still another aspect of the invention, the comment database further includes one or more tips prepared respectively for each question in the question database. The tips are each designed to give a student a tip on the answer to a question. In addition, the wrong answer comment is further designed to let a student know that he/she may request a tip on the answer to a question. The method further comprises the step of, when the student requests a tip to the question, selecting from the comment database a tip corresponding to the question for sending it to the terminal in step (e).

In accordance with a described embodiment, more than one tip addressed to the same question is each designed to contain a tip different from the others. They are also assigned the order in which the tips are provided to a student so that tips are given to the student in a step-by-step manner. The step of selecting a tip is a step of, when more than one tip is addressed to the question, selecting a tip based on the number of times the student has requested a tip, and the order assigned to each tip.

Furthermore, when more than one tip is consecutively given to the student in response to his/her consecutive requests, step (e) sends the selected tip in such a way that a newly selected tip following a previously selected tip is sent after the expiration of a predetermined interval.

In accordance with yet another aspect of the invention, the comment database further includes one or more tips prepared respectively for each question in the question database. The tips are each designed to give a student a tip on the answer to a question. The method further comprises the steps of, before step (c) or (d) is performed, determining whether the answer is blank, and if so, selecting from the comment database a tip corresponding to the question given to the student for sending it to the terminal in step (e).

In a described embodiment, more than one tip addressed to the same question is each designed to contain a tip different from the others. They are also assigned the order in which the tips are provided to a student so that tips are given to the student in a step-by-step manner. When more than one tip is addressed to the question, tips are selected based on the number of times the answer is left blank and the order assigned to each tip.

Furthermore, when more than one tip is consecutively given to the student in response to his/her consecutive answers left blank, step (e) sends the selected tip in such a way that a newly selected tip following a previously selected tip is sent after the expiration of a predetermined interval.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

FIG. 1 is a block diagram showing a remote teaching system of an embodiment according to the invention.

FIG. 2 is a block diagram showing a structure of a database shown in FIG. 1.

FIG. 3 is a flow chart showing steps of performing a method for providing remote teaching according to the invention.

FIG. 4 is a schematic view showing a structure of a comment section shown in FIG. 2.

FIG. 5 is a diagram showing example tips to a question “prove the Pythagorean theorem.”

FIG. 6 is a block diagram showing a conventional remote teaching system.

### DETAILED DESCRIPTION OF THE INVENTION

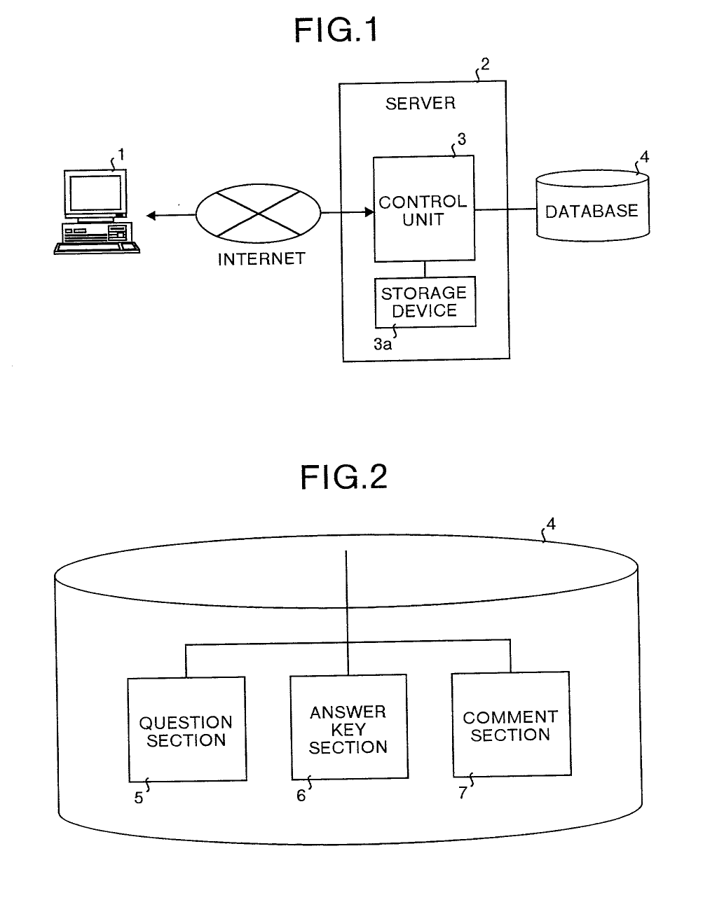

An embodiment of the present invention will be described in detail with reference to the accompanying drawings. FIG. 1 shows a remote teaching system of one embodiment according to the invention, which includes a terminal 1, such as a personal computer, located at a student side of this remote teaching system. The system also includes a server 2 located at a provider side of this remote teaching system, a control unit 3 (including a processor and main memory) for analyzing an answer sent from the terminal 1 and for controlling operations performed in server 2, and a database 4, each of which is connected to the terminal 1 through the Internet. The server 2 also includes a storage device 3a, such as a magnetic disk or optical disk for storing information and instructions.

The invention is related to the use of the server 2 for providing remote teaching to a student. According to one embodiment of the invention, remote teaching is provided by the server 2 in response to the processor executing one or more sequences of one or more instructions contained in the main memory. Such instructions may be read into the main memory from another computer-readable medium, such as the storage device 3a. Execution of the sequences of instructions contained in the main memory causes the processor to perform the process steps described herein. One or more processors in a multi-processing arrangement may also be employed to execute the sequences of instructions contained in the main memory. In alternative embodiment, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor for execution. Such a medium may take many forms, including but not limited to, non-volatile media, volatile media, and transmission media. Non-volatile media include, for example, optical or magnetic disks, such as the storage device 3a. Volatile media include dynamic memory, such as the main memory. Transmission media include coaxial cables, copper wire and fiber optics, including the wires that comprise a bus. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASHEPROM, any other memory chip or cartridge, a carrier wave, or any other medium from which a computer can read.

Various forms of computer readable media may be involved in carrying one or more sequences of one or more instructions to the processor for execution. For example, the instructions may initially be borne on a magnetic disk of a remote computer. The remote computer can load the instructions into its dynamic memory and send the instructions over a telephone line using a modem. A modem (not shown) local to server 2 can receive the data on the telephone line and use an infrared transmitter to convert the data to an infrared signal. An infrared detector coupled to a bus (not shown) can receive the data carried in the infrared signal and place the data on the bus. The bus carries the data to the main memory, from which the processor retrieves and executes the instructions. The instructions received by the main memory may optionally be stored on the storage device 3a either before or after execution by the processor.

FIG. 2 shows the structure of the database 4. As shown in FIG. 2, the database 4 includes a question section 5, an answer key section 6, and a comment section 7.

A student initially operates the terminal 1 to access the server 2, and then obtains a web page (not shown) provided by the server 2. At this time, the identity of the student is checked on the basis of his/her password, PIN number or the like to ensure security against unauthorized access. The student then selects on the web page a course of study, subject, difficulty and so forth, concerning which he/she wants to learn, and obtain a question(s) corresponding to the student's selection from the server 2.

As for a manner of obtaining a question(s), the student may obtain a question(s) through e-mail sent from the server 2 or obtain questions through a computer-readable medium such as CD-ROM, in addition to downloading a question(s) from the server 2 over the Internet.

The student gives consideration to the question obtained from the server 2, answers the question, and sends the answer to the server 2 over the Internet.

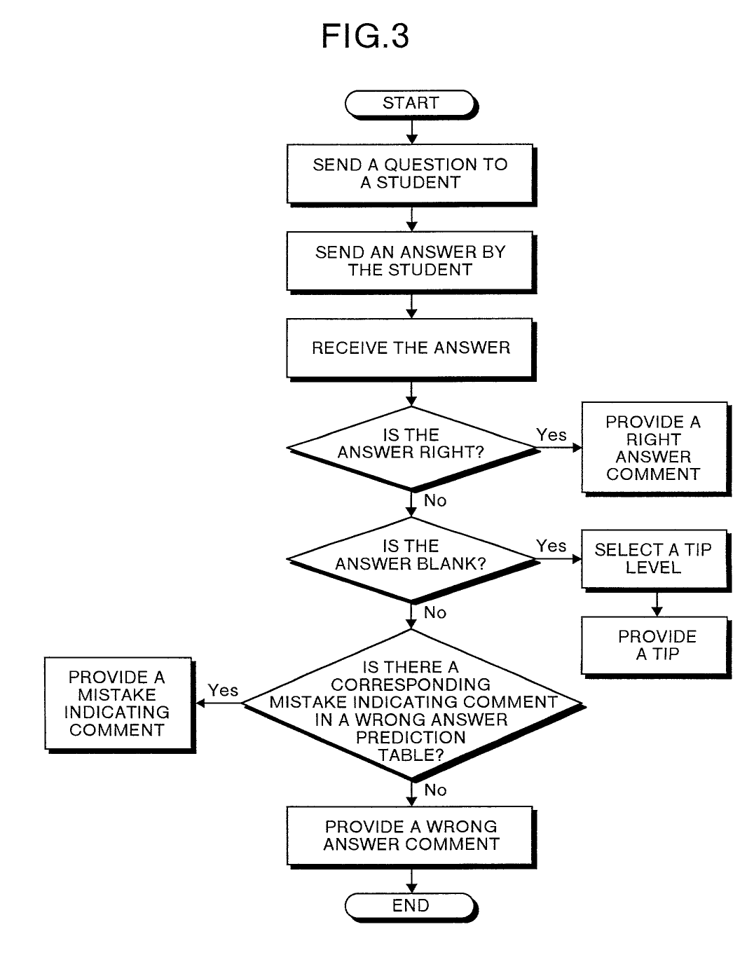

The answer is received with the server 2 through the Internet. The control unit 3 in the server 2 then analyzes the answer along with steps shown in the flow chart of FIG. 3, and sends the terminal 1 a right answer comment, a wrong answer comment, a mistake indicating comment or a tip.

The above-described process will be explained in detail with reference to FIG. 3. When an answer transmitted from the student is received with the server 2, the control unit 3 in the server 2 initially retrieves a right answer to the question given to the student from the answer key section 6 in the database 4. The control unit 3 then compares the answer from the student with the right answer from the answer key section 6 to determine whether the student's answer is right or not. When the answer is right, a right answer comment is provided to the student. The right answer comment includes a comment which lets the student know that his/her answer is right and know that he/she may go on to the next question. The right answer comment is previously created and stored in the answer key section 6 shown in FIG. 2. The right answer comment may be displayed on a web page by means of Java applets or the like, or sent to the student by e-mail.

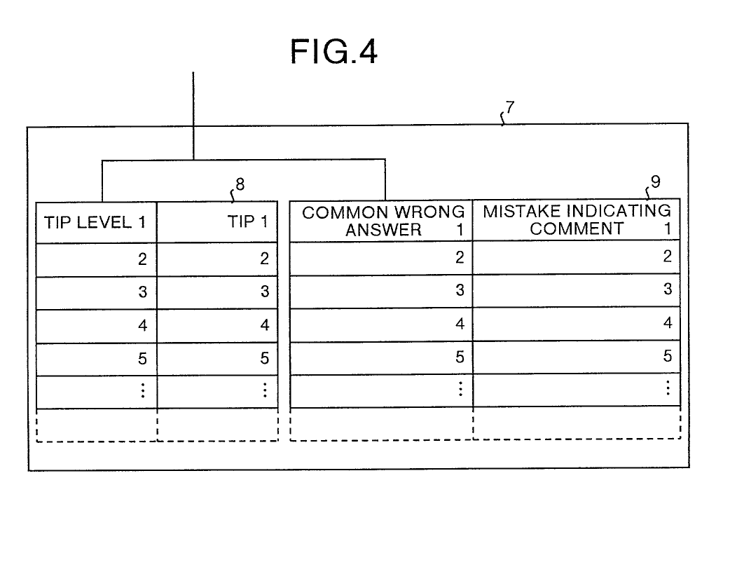

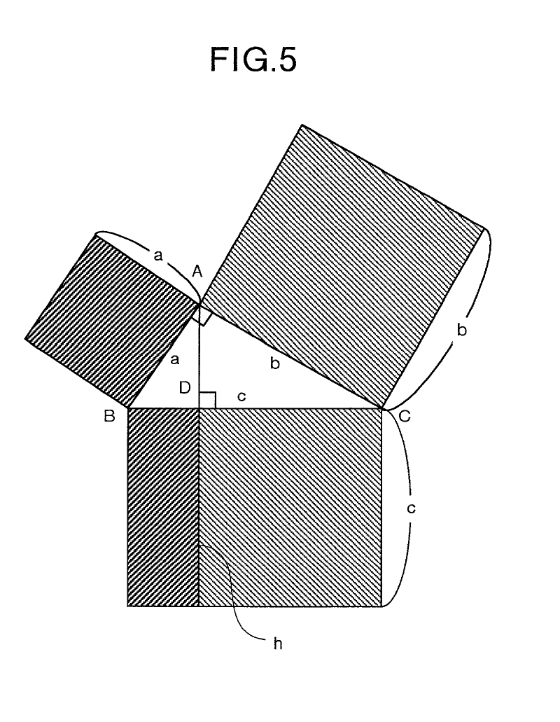

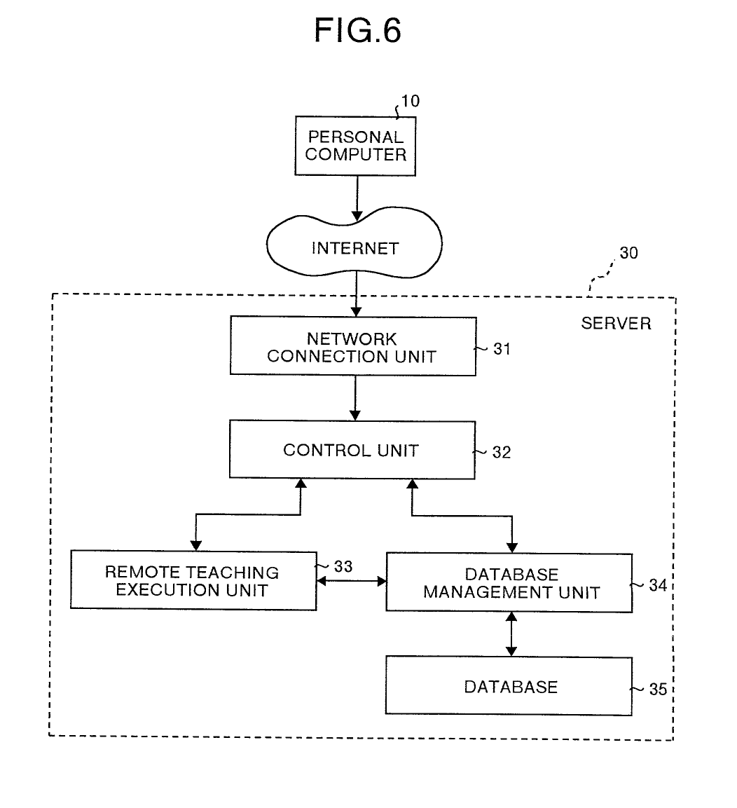

If the answer is not right, then the control unit 3 determines whether the answer is blank or not. (For example, this may happen when the student takes an action for sending his/her answer at the terminal 1 without input of his/her answer into an answer space provided on a web page.) When the answer is blank, the control unit 3 provides a tip to the student. As shown in FIG. 4, this tip is included in a tip table 8 provided in the comment section 7. A plurality of tip tables 8 are prepared respectively for each question in the question section 5, and each include one or more tips each designed to give a student a tip on the answer to a question given to him/her. If more than one tip is addressed to the same question, they are each designed to contain a tip different from the others and are assigned the order (level) in which the tips are provided to a student so that tips are given to the student in a step-by-step manner. In this case, when the answer is blank, one of the tips is selected based on the number of times the answer is left blank and the order (level) assigned to each tip. That is, as shown below, a tip assigned the order (level) corresponding to the number of times the answer is left blank, is to be selected.

For example, if the first answer to a question given to the student is blank, a tip on the first level will be provided to the student (the first level tip and the first answer). If the second answer to the same question is also blank, a tip on the second level will be provided to the student (the second level tip and the second answer). Prior to providing a tip, the control unit 3 selects a tip level for a tip to be provided to the student in the tip table 8 so that an appropriate tip is provided to the student. The tip level may be selected depending on the number of times the answer is left blank, as mentioned in the above example. This tip may be displayed on a web page by means of Java applets, or sent to the student by e-mail or the like.

The reason why a tip is provided to the student in a step-by-step manner is to prompt a student to make an effort to answer a question, instead of immediately giving him/her an answer to the question, even though the student has no idea about how to answer the question. Such a system attaching great importance to interaction with a student is realized by the invention because the invention effectively utilizes the real time nature of the Internet (derived from a two-way communication). A detailed explanation for the tip table 8 will be made below.

It should be noted that there is no problem if the steps in FIG. 3 are changed, e.g., the step of determining whether an answer is blank may be performed before the step of determining whether an answer is right.

Returning to the step of determining whether the answer is blank, if it is determined that the answer is not blank, then the control unit 3 provides the student with a mistake indicating comment selected from a wrong answer prediction table 9 in the comment section 7. A plurality of wrong answer prediction tables 9 as shown in FIG. 4 are prepared respectively for each question included in the question section 5. The wrong answer prediction table 9 shown in FIG. 4 includes one or more common wrong answers students are apt to make, which may be anticipated from a corresponding question. The wrong answer prediction table 9 further includes one or more mistake indicating comments prepared in compliance with the respective common wrong answers. The mistake indicating comments are comments that not only tell a student that his/her answer is wrong, but also the reason his/her answer is wrong, and prompt him/her to consider the question again paying special attention to such mistake. In selecting a mistake indicating comment, the control unit 3, for example, looks for a wrong answer prediction table 9 associated with a question given to a student. The control unit 3 then looks up a common wrong answer corresponding to a student's wrong answer from the wrong answer prediction table 9 to get an appropriate mistake indicating comment for providing it to the student. Such a system attaching great importance to interaction with a student is realized by the invention because the invention effectively utilizes the real time nature of the Internet (derived from a two-way communication). A detailed explanation for the wrong answer prediction table 9 will be made below.

Common wrong answers in the wrong answer prediction table 9 may preferably be created on the basis of prediction of persons skilled in education. More preferably, those common wrong answers may be created based on an analysis of a result of an exam widely held for students. In this case, the wrong answer prediction table 9 may be created in the following way. As a result of the exam, various sample answers are obtained every question, so that one or more wrong answers to each question may be obtained from the sample answers. The wrong answers obtained for every question are ranked in a predetermined manner, and some of high ranking answers are picked up to constitute common wrong answers in wrong answer prediction table 9 corresponding to a question from which those wrong answers obtained. After that, the cause of making an answer wrong is considered for each common wrong answer. A result of consideration of the cause gets related as a mistake indicating comment to the common wrong answer, from which a mistake indicating comment is derived. Because the wrong answer prediction table 9 is prepared in the above manner, any of the mistake indicating comments may be sent to almost all students when they make a mistake. As apparent from the above explanation, the wrong answer prediction table 9 may relatively easily be created.

There is a possibility that there is no common wrong answer corresponding to a student's answer in the wrong answer prediction table 9. That is, there may be cases where no mistake indicating comment for the student who makes a mistake is found in the wrong answer prediction table 9. In preparation for this case, a wrong answer comment may preferably be prepared in the comment section 7. The wrong answer comment is a comment that lets a student know that his/her answer is wrong. The wrong answer comment also may include a comment that lets a student know that he/she can request a tip on the answer to a question given to him/her.

For instance, if an answer of a student is wrong and is not found in the wrong answer prediction table 9, then the wrong answer comment will be displayed on a web page. Simultaneously, it may be possible to display a comment “Do you need a tip?” If the student requests a tip, the above-described tip will be displayed on a web page in the same manner described above.

As explained above, the provider of this remote teaching system can obtain right and wrong answer data (a learning history) of each student, based on which the provider can make an individual database for each student. As an alternative embodiment of the invention, such individual databases for respective students may be added to the system shown in FIG. 1 in order to select more appropriate questions for each student when a question is provided to him/her. Stated differently, it becomes possible to analyze a tendency of mistakes each student made in the past by referencing the individual databases, so that questions similar to those with which a student had trouble may be provided to him/her. Therefore, the student may effectively learn his/her weak points.

In addition, referring to the individual database can prevent questions that have already been provided to a student from being sent to him/her again. Furthermore, adding to the individual database information regarding a school(s) into which the student wants to enroll, makes it possible to select questions from old entrance exams of the school, in the same manner mentioned above. The questions of old entrance exams may be stored in the question section 5 shown in FIG. 2.

In the following, the tip table 8 will be explained in detail with reference to an example shown in FIG. 5. FIG. 5 shows a question asking a student to prove the well-known Pythagorean theorem. As a question, a drawing showing a right-angled triangle and squares that contacts with respective sides of the right-angled triangle is provided to a student to ask him/her to prove an equation “a²+b²=C².”

When the student requests a tip as to the question, a drawing in which an auxiliary line h as shown in FIG. 5 is added to the original drawing will be provided to the student as a comment of the tip level 1, in addition to the original drawing.

When the student requests a tip again, a predetermined interval will be given the student. Giving the student the interval urges him/her to deeply consider the question by him/herself, and avoids him/her from easily getting a next tip. Desired time may be set as the interval. This interval may also be adapted to the case when a student's answer is left blank, followed by sending a tip.

After the expiration of the interval, a drawing in which hatching as shown in FIG. 5 is added to the original drawing as well as the auxiliary line h, is provided to the student as a comment of the tip level 2.

When the student further requests a tip, a predetermined interval will be given the student again. After the expiration of the interval, a comment “Attention to similarity in relations between triangles ABD and ABC, and between triangles ACD and ABC” is provided as a comment of the tip level 3 to the student, in addition to the drawing shown in FIG. 5.

Providing a student with tips in a step-by-step manner, instead of immediately providing a right answer, allows construction of a remote teaching system capable of fitting respective students of varying levels.

For a person skilled in the art to which this invention pertains, it is easy to make this kind of a tip table 8 by referring to the above explanation.

In the following, the wrong answer prediction table 9 will be explained. Assuming that a question is to perform an operation to find value of (A+B)×C, where A=2.10, B=3.20 and C=4.70. The right answer to the question is 24.9.

One example of common wrong answers is 17.1, which is derived from an equation A+B×C, not (A+B)×C. Based on this common wrong answer, a comment “Be careful of order of ‘+’ and ‘×’” may be prepared as a mistake indicating comment for pointing out the cause of the above mistake. Another example of common wrong answers is 24.91. As a comment for this answer, a comment “Be careful of the number of significant figures” may be prepared as a mistake indicating comment.

If a student's answer to the above question is 17.1, the control unit 3 selects the comment “Be careful of order of ‘+’ and ‘×’” for providing it to a student who sent the above answer. On the other hand, if a student's answer to the above question is 24.91, the control unit 3 also selects the comment “Be careful of the number of significant figures” for providing it to a student who sent the above answer.

As described above, according to the invention, the control unit 3 in the server 2 determines whether an answer to a question given to a student is right or not, and when it is determined that the answer is not right, selects a mistake indicating comment corresponding to both the question given to the student and his/her answer to the question for providing it to him/her. This makes it possible to point out the cause of making the student's answer wrong, and to prompt the student to reconsider the question deeply based on his/her mistake.

The control unit 3 also may provide the student with a tip when he/she requests a tip or his/her answer is blank, making it possible to help him/her answer the question correctly. Various tips each including a tip different from the others may be prepared every question, which may allow the control unit 3 to give the student tips in a step-by-step manner. Therefore, remote teaching that is capable of fitting respective students of varying levels may be provided. When tips are provided to the student in a step-by-step manner, the order in which the tips are provided depends on the number of times the student has requested a tip or the number of times the answer is left blank, and the level (the order) assigned to each tip as shown in FIG. 4. Therefore, an appropriate tip which appears to help the student answer the question correctly may be selected every time the student requests a tip or an answer is left blank. Furthermore, when tips are provided to the student in a step-by-step manner, a predetermined interval is imposed between the sending of a previously selected tip and a newly selected tip. This urges the student to deeply consider the question by him/herself, and avoids him/her from easily getting a next tip.

The control unit 3 refers to an individual database for a student to whom a question is to be given when selecting a question. Since the individual database includes a learning history of the student obtained through the remote teaching, it is possible to find out what kinds of questions the student has trouble with. Therefore, appropriate questions for the student may be selected from the question database by referencing to the individual database.

In this disclosure, there is shown and described only the embodiment of the invention, but, as aforementioned, it is to be understood that the invention is capable of use in various other combinations and environments and is capable of changes or modifications within the scope of the inventive concept as expressed herein.

What is claimed is:

1. An apparatus for providing remote teaching to a student at a terminal connected to the apparatus through a network, comprising:
a question database including questions to be given to students;
an answer database including an answer key for the questions in the question database;
a comment database including one or more common wrong answers students are apt to make, prepared respectively for each question in the question database, and mistake indicating comments corresponding to the respective common wrong answers, the mistake indicating comments each designed to let a student know that his/her answer is wrong and why; and
a control unit configured to, after an answer to a question given to the student is received from the terminal through the network, determine based on the answer key whether the answer is right, and when it is determined that the answer is not right, select from the comment database a mistake indicating comment corresponding to both the question given to the student and his/her answer for providing the comment to the student through the network.

2. An apparatus according to claim 1, wherein the common wrong answers are answers obtained from a result of an examination for students.

3. An apparatus according to claim 1, wherein the comment database further includes a wrong answer comment designed to let a student know that his/her answer is wrong, and
wherein the control unit is further configured to select the wrong answer comment for providing it to the student when the control unit has found no mistake indicating comment corresponding to both the question given to the student and his/her answer.

4. An apparatus according to claim 3, wherein the comment database further includes one or more tips prepared respectively for each question in the question database, the tips each designed to give a student a tip on the answer to a question given to him/her,
wherein the wrong answer comment is further designed to let a student know that he/she may request a tip on the answer to a question given to him/her, and
wherein the control unit is further configured to, when the student requests a tip to the question, select from the comment database a tip corresponding to the question for providing the tip to the student through the network.

5. An apparatus according to claim 4, wherein more than one tip addressed to the same question is each designed to contain a tip different from the others and is assigned the order in which the tips are provided to a student so that tips are given to the student in a step-by-step manner, and
wherein the control unit is configured to, when more than one tip is addressed to the question given to the student, select one of the tips based on the number of times the student has requested a tip to the question given to him/her, and the order assigned to each tip.

6. An apparatus according to claim 5, wherein the control unit is configured to, when more than one tip is consecutively given to the student in response to his/her consecutive requests of a tip to the same question, control the sending of the selected tip in such a way that a newly selected tip following a previously selected tip is sent after the expiration of a predetermined interval.

7. An apparatus according to claim 1, wherein the comment database further includes one or more tips prepared respectively for each question in the question database, the tips each designed to give a student a tip on the answer to a question given to him/her, and
wherein the control unit is further configured to determine whether the answer to the question is blank, and when it is determined that the answer is blank, select from the comment database a tip corresponding to the question for providing the tip to the student through the network.

8. An apparatus according to claim 7, wherein more than one tip addressed to the same question is each designed to contain a tip different from the others and is assigned the order in which the tips are provided to a student so that tips are given to the student in a step-by-step manner, and
wherein the control unit is configured to, when more than one tip is addressed to the question given to the student, select one of the tips based on the number of times the answer is left blank and the order assigned to each tip.

9. An apparatus according to claim 8, wherein the control unit is configured to, when more than one tip is consecutively given to the student in response to his/her consecutive answers left blank, control the sending of the selected tip in such a way that a newly selected tip following a previously selected tip is sent after the expiration of a predetermined interval.

10. An apparatus according to claim 1, further comprising personal databases storing respective students' personal information, the personal information which includes a learning history of a student obtained through this remote teaching, and
wherein the control unit is further configured to refer to the individual database for a student to whom a question is to be given, to select a question appropriate for him/her from the question database.

11. A method for providing remote teaching to a student, in which a server for a provider of the remote teaching and a terminal for a student who takes the remote teaching are connected through a network so that the provider provides the student with the remote teaching over the network, comprising the steps of:
(a) sending to the terminal a question selected from a question database which includes questions to be given to students;
(b) receiving from the terminal an answer to the question;
(c) determining whether the answer is right;
(d) when it is determined that the answer is not right, referencing a comment database including one or more common wrong answers students are apt to make, prepared respectively for each question in the question database, and mistake indicating comments corresponding to the respective common wrong answers, the mistake indicating comments each designed to let a student know that his/her answer is wrong and why, to select a mistake indicating comment corresponding to both the question given to the student and his/her answer; and
(e) sending the selected comment to the terminal.

12. A method according to claim 11, wherein step (a) includes referencing a personal database storing personal information for the student to whom a question is to be given, to select a question appropriate for the student from the question database.

13. A method according to claim 12, further comprising the step of recording a learning history of each student through the remote teaching to build his/her personal information.

14. A method according to claim 11, wherein step (d) includes selecting a wrong answer comment included in the comment database when any mistake indicating comment corresponding to both the question given to the student and his/her answer has not found, the wrong answer comment designed to let a student know that his/her answer is wrong.

15. A method according to claim 11, wherein the comment database further includes one or more tips prepared respectively for each question in the question database, the tips each designed to give a student a tip on the answer to a question given to him/her, and
the method further comprising the steps of:
before step (c) or (d) is performed, determining whether the answer is blank; and
when it is determined that the answer is blank, selecting from the comment database a tip corresponding to the question given to the student for sending it to the terminal in step (e).

16. A method according to claim 15, wherein more than one tip addressed to the same question is each designed to contain a tip different from the others and is assigned the order in which the tips are provided to a students so that tips are given to the student in a step-by-step manner, and
wherein the step of selecting a tip is a step of, when more than one tip is addressed to the question given to the student, selecting a tip based on the number of times the answer is left blank and the order assigned to each tip.

17. A method according to claim 16, wherein when more than one tip is consecutively given to the student in response to his/her consecutive answers left blank, step (e) sends the selected tip in such a way that a newly selected tip following a previously selected tip is sent after the expiration of a predetermined interval.

18. A computer-readable medium bearing instructions for providing remote teaching to a student over a network, the instructions, when executed, causing one or more processors to perform the steps of:
(a) sending to the terminal a question selected from a question database which includes questions to be given to students;
(b) receiving from the terminal an answer to the question;
(c) determining whether the answer is right;
(d) when it is determined that the answer is not right, referencing a comment database including one or more common wrong answers students are apt to make, prepared respectively for each question in the question database, and mistake indicating comments corresponding to the respective common wrong answers, the mistake indicating comments each designed to let a student know that his/her answer is wrong and why, to select a mistake indicating comment corresponding to both the question given to the student and his/her answer; and
(e) sending the selected comment to the terminal.

19. A computer-readable medium according to claim 18, wherein step (d) includes selecting a wrong answer comment included in the comment database when any mistake indicating comment corresponding to both the question given to the student and his/her answer has not found, the wrong answer comment designed to let a student know that his/her answer is wrong.

20. A computer-readable medium according to claim 18, wherein the comment database further includes one or more tips prepared respectively for each question in the question database, the tips each designed to give a student a tip on the answer to a question given to him/her, and
the instructions, when executed, causes one or more processors to perform the steps of:
before step (c) or (d) is performed, determining whether the answer is blank; and
when it is determined that the answer is blank, selecting from the comment database a tip corresponding to the question given to the student for sending it to the terminal in step (e).
